(19) United States
(12) Patent Application Publication
(10) Pub. No.: US 2024/0345120 A1
(43) Pub. Date: Oct. 17, 2024

(54) LABORATORY APPARATUS, LABORATORY SYSTEM, AND USE

(71) Applicant: Roche Diagnostics Operations, Inc., Indianapolis, IN (US)

(72) Inventors: Leon Felipe Apodaca Lujan, Markgroningen (DE); Timo Gutmann, Dannstadt-Schauernheim (DE)

(73) Assignee: Roche Diagnostics Operations, Inc., Indianapolis, IN (US)

(21) Appl. No.: 18/750,107

(22) Filed: Jun. 21, 2024

Related U.S. Application Data
(63) Continuation of application No. PCT/EP2022/086788, filed on Dec. 19, 2022.

(30) Foreign Application Priority Data
Dec. 21, 2021 (EP) 21216494.1

(51) Int. Cl. G01N 35/04

(52) U.S. Cl. CPC G01N 35/04; G01N 2035/0401; G01N 2035/0496

(57) ABSTRACT

A laboratory apparatus comprising a housing, wherein the housing comprises a through-opening, wherein the through-opening is adapted for passing through it a transport device for transporting laboratory sample containers in and/or out of the housing, and a cover, wherein the cover comprises at least two ring segments, wherein the ring segments are adjustable to each other between a distant adjustment with at least one distance in between ends of the ring segments for arranging them around the passed through transport device and a near adjustment with less or no distance in between the ends of the ring segments for surrounding the passed through transport device, and wherein the cover in the near adjustment is adapted to cover a part of the through-opening left free by the passed through transport device, wherein the laboratory apparatus is a pre-analytical, analytical, and/or post-analytical laboratory apparatus, in particular a sorting module.

### TECHNICAL FIELD

The invention relates to a laboratory apparatus comprising a housing and a cover, to a laboratory system comprising such a laboratory apparatus, and to a use of such a cover with such a housing of such a laboratory apparatus and/or such a laboratory system.

### SUMMARY OF THE INVENTION

It is an object of the invention to provide for a laboratory apparatus comprising a housing and a cover comprising improved properties, in particular enabling safety in an easy way. It is a further object of the invention to provide for a laboratory system comprising such a laboratory apparatus, and to provide for a use of such a cover with such a housing of such a laboratory apparatus and/or such a laboratory system.

This object is solved by a laboratory apparatus, a laboratory system, and a use with the features of the respective independent claims. Preferred embodiments are defined in the dependent claims.

The invention relates to a laboratory apparatus. The laboratory apparatus comprises a housing and a cover. The housing comprises a through-opening. The through-opening is adapted for passing through it a transport device for transporting laboratory sample containers in and/or out of the housing. The cover comprises at least two ring segments. The ring segments are adjustable to each other between a distant adjustment with at least one distance in between ends of the ring segments for arranging them around the passed through transport device and a near adjustment with less or no distance in between the ends of the ring segments for surrounding the passed through transport device. The cover in the near adjustment is adapted to cover a part of the through-opening left free by the passed through transport device.

This enables, in particular the distant adjustment and the near adjustment enable, an easy assembly or attachment, respectively, of the cover at the housing. Additionally or alternatively this, in particular the cover covering the part of the through-opening, enables leaving less or no gap in between the housing or an outer edge of the through-opening, respectively, and the transport device. Thus, this enables a reduction or a prevention of a risk of, in particular inadvertent, reaching of a person in the housing through the through-opening. Thus, this enables a reduction or a prevention of a risk of, in particular inadvertent, injuries, in particular of the person, or external disturbances in a workflow, in particular of the laboratory apparatus and/or the transport device.

In particular the laboratory apparatus may be a laboratory handling apparatus for handling the laboratory sample containers.

The laboratory sample containers may be tubes. Additionally or alternatively the laboratory sample containers may be adapted to contain laboratory samples.

The laboratory samples may be, in particular body, liquids or fluids, respectively, in particular blood samples.

The term/s “has/have” may be used synonymously for the term/s “comprise/s”.

The term “configured” may be used synonymously for the term “adapted”.

The term “shield” may be used synonymously for the term “housing”. Additionally or alternatively the housing may be adapted to house the laboratory sample containers. Additionally or alternatively the housing and the cover may be different or, in particular completely, separate from each other, respectively, in particular in the distant adjustment.

The cover may comprise exactly two ring segments. Additionally or alternatively the ring segments may be different or, in particular completely, separate from each other, respectively, in particular in the distant adjustment. Additionally or alternatively the cover or its ring segments, respectively, may be rigid or of stable shape, respectively.

The term “positionable” may be used synonymously for the term “adjustable”. Additionally or alternatively the term “position” may be used synonymously for the term “adjustment”. Additionally or alternatively the distant adjustment may be an interrupted or disconnected, respectively, adjustment with at least one interruption or disconnection, respectively, in between the ends of the ring segments. Additionally or alternatively the near adjustment may be an uninterrupted or connected, respectively, adjustment without the at least one interruption or with at least one connection, respectively, in between the ends of the ring segments. In particular the connection may be mechanical.

The distance, in particular a value of the distance, may be greater than zero.

The distant adjustment may be with at least, in particular exactly, two distances in between the ends of the ring segments.

The ends of the ring segments may be at least two, in particular exactly four, ends of the ring segments.

The ring segments, in particular each, may comprise an internal or inner, respectively, shape or cross-section or edge, respectively, being semi-circular.

The cover or its ring segments, respectively, in the near adjustment may be continuous or closed or comprising or forming, respectively, a closed ring shape, respectively.

The surrounding may be continuous or uninterrupted or complete, respectively. Additionally or alternatively the term “enclosing” may be used synonymously for the term “surrounding”.

In the distant adjustment the ring segments may not or does not have to be adapted for surrounding the passed through transport device. Additionally or alternatively in the near adjustment the ring segments may not or does not have to be adapted for arranging them around the passed through transport device.

The cover in the near adjustment may denote with its ring segments in the near adjustment.

The cover in the near adjustment may be adapted to cover only the part of the through-opening and/or the part completely.

The term “close” or “shut” may be used synonymously for the term “cover”.

The term “portion” may be used synonymously for the term “part”.

The part of the through-opening left free by the passed through transport device may denote a gap in between the housing or an outer edge of the through-opening, respectively, and the transport device. In other words: The cover may fill the gap between the connected devices.

The laboratory apparatus is a pre-analytical, analytical, and/or post-analytical laboratory apparatus, in particular a sorting module.

According to an embodiment of the invention, the cover, in particular in the near adjustment, is displaceable along the through-opening, in particular without the transport device passing through the through-opening. In particular the through-opening defines an opening-normal. The cover is displaceable at least along at least one direction being non-parallel, in particular orthogonal, to the opening-normal. This enables a compensation of or overcoming, respectively, tolerances of an alignment of the housing, in particular its through-opening, and the transport device, in particular passing through the through-opening, to each other. In particular the cover may be displaceable along, in particular exactly, two directions being non-parallel, in particular orthogonal, to the opening-normal.

According to an embodiment of the invention, the cover comprises an unmounted, and in particular unfixed, state with the cover unmounted, and in particular unfixed, with respect to the through-opening, in particular to the housing, for adjusting the ring segments between the distant adjustment and the near adjustment. Additionally or alternatively the cover comprises a mounted, and in particular unfixed, state with the cover mounted, and in particular unfixed, with respect to the through-opening, in particular to the housing, for displacing the cover along the through-opening. Additionally or alternatively the cover comprises a fixed state with the cover fixed with respect to the through-opening, in particular to the housing, for covering the part of the through-opening. This, in particular the unmounted state, enables an easy adjusting of the ring segments between the distant adjustment and the near adjustment. Additionally or alternatively, this, in particular the mounted state, enables an easy displacing of the cover along the through opening. Additionally or alternatively this, in particular the fixed state, enables a safe covering of the part of the through-opening. In particular the term “captive” or “hold” or “floating” may be used synonymously for the term “mounted”. Additionally or alternatively the term “fastened” may be used synonymously for the term “fixed”. Additionally or alternatively the fixed may be stationary. Additionally or alternatively the cover in the fixed state may not or does not have to be displaceable along the through-opening, in particular the at least one direction being non-parallel, in particular orthogonal, to the opening-normal, and/or a direction being non-orthogonal, in particular parallel, to the opening-normal. Additionally or alternatively the cover in the mounted state may not or does not have to be displaceable along the direction being non-orthogonal, in particular parallel, to the opening-normal. Additionally or alternatively the unmounted state, the mounted state and/or the fixed state may be different from each other.

According to an embodiment of the invention, the laboratory apparatus comprises mounting and/or fixing means. The mounting and/or fixing means are adapted for mounting and/or fixing the cover with respect to the through-opening, in particular to the housing, and comprise: a plurality of through-holes in the cover, in particular in at least one of the ring segments and/or extending from a housing side of the cover to an opposite side of the cover, a plurality of shafts and a plurality of rest elements. The plurality of shafts is adapted for passing through the, in particular corresponding, plurality of through-holes from the housing away, in particular from the housing side of the cover to the opposite side of the cover. The plurality of rest elements is adapted for resting on the cover, in particular at its opposite side, and for applying a force to the cover towards the housing by means of the, in particular corresponding, plurality of shafts, in particular passing through the plurality of through-holes. In particular the plurality of through-holes, the plurality of shafts and the plurality of rest elements are dimensioned for the mounted state and/or the fixed state. In particular the term “fastening” may be used synonymously for the term “fixing”. Additionally or alternatively the plurality of through-holes may be in the two ring segments. Additionally or alternatively the plurality of shafts may be, in particular externally, threaded. Additionally or alternatively the housing may comprise a plurality of, in particular internal, threads for screwing in the plurality of threaded shafts and/or the plurality of shafts may be fixed to the housing. Additionally or alternatively the plurality of rest elements may be a plurality of screw heads, nuts and/or washers. Additionally or alternatively the plurality of shafts and the plurality of rest elements may be a plurality of screws. Additionally or alternatively the plurality of rest elements, in particular the plurality of screws and/or the plurality of nuts, may be loose or untightened, respectively, for the mounted state and/or tightened for the fixed state. Additionally or alternatively a dimension, in particular of a value of the dimension, of the plurality of through-holes may be, in particular two times, greater than a dimension, in particular of a value of the dimension, of the plurality of shafts, in particular along the through-opening. Additionally or alternatively a dimension, in particular of a value of the dimension, of the plurality of rest elements may be greater than a dimension, in particular of a value of the dimension, of the plurality of through-holes, in particular along the through-opening. Additionally or alternatively the dimension may be a diameter. Additionally or alternatively the force may be a pull force for pulling the cover towards the housing. Additionally or alternatively the mounting and/or fixing means may be arranged to the side next to, in particular around, the through-opening. Additionally or alternatively the plurality of through-holes may extend, the plurality of shafts may be adapted for passing through the plurality of through-holes and/or the plurality of rest elements may be adapted for applying the force along the direction being non-orthogonal, in particular parallel, to the opening-normal. The mounting and/or the fixing and/or the resting may be directly.

According to an embodiment of the invention, the cover is adapted for resting on the housing, in particular at its outside, for covering the part of the through-opening. This enables leaving less or no gap in between the housing or an outer edge of the through-opening, respectively, and the cover. In particular the resting may be directly.

According to an embodiment of the invention, the cover, in particular in the near adjustment, is a cover plate. Additionally or alternatively the housing, in particular at its outside, in the region of its through-opening is plane. In particular the cover and/or its ring segments may be, in particular only, two-dimensional and/or comprise a constant thickness. Additionally or alternatively the term “area” or “range” may be used synonymously for the term “region”.

According to an embodiment of the invention, the distant adjustment is an unjoined adjustment with no joint between the ends of the ring segments. The near adjustment is a joined adjustment with at least one joint between the ends of the ring segments. This enables an easy displacing of the cover along the through opening and/or a safe covering of the part of the through-opening. In particular the joint may be mechanical.

According to an embodiment of the invention, the through-opening defines an, in particular the, opening-normal. The ring segments, in particular with their ends, are adjustable to each other between the distant adjustment and the near adjustment at least, in particular firstly, sectionally along, in particular the, at least one direction being non-parallel, in particular orthogonal, to the opening-normal and/or at least, in particular secondly, sectionally along a, in particular the, direction being non-orthogonal, in particular parallel, to the opening-normal. This, in particular the adjusting along the at least one direction being non-parallel, in particular orthogonal, to the opening-normal, enables arranging the rings segments around the passed through device. Additionally or alternatively this, in particular the adjusting along the direction being non-orthogonal, in particular parallel, to the opening-normal, enables forming the at least one joint between the ends of the ring segments. In particular the ring segments may be adjustable to each other along, in particular exactly, two directions being non-parallel, in particular orthogonal, to the opening-normal.

According to an embodiment of the invention, at least one of the ring segments comprises at its end a tab and at least another one of the ring segments comprises at its end a corresponding indentation for receiving the tab for joining the ends of the ring segments, in particular for the joined adjustment. This enables an easy and/or strong joint, in particular like a jigsaw puzzle. In particular the term “interjamb” may be used synonymously for the term “tab”. Additionally or alternatively the term “blank” may be used synonymously for the term “indentation”. Additionally or alternatively the term “complentary” may be used synonymously for the term “corresponding”. Additionally or alternatively the term “interlocking” may be used synonymously for the term “joining”. Additionally or alternatively the joint may be a dovetail joint.

According to an embodiment of the invention, the laboratory apparatus comprises an alignment mechanism. The alignment mechanism is adapted for aligning the housing, in particular with its through-opening, with respect to a support, in particular a ground floor, for supporting the laboratory apparatus. In particular the through-opening defines an, in particular the, opening-normal. The alignment mechanism is adapted for aligning the housing at least along, in particular the, at least one direction being non-parallel, in particular orthogonal, to the opening-normal. This enables a compensation of or overcoming, respectively, an unevenness of the support and/or a set up inaccuracy. In particular the alignment mechanism may be adapted for aligning the housing along, in particular exactly, two directions being non-parallel, in particular orthogonal, to the opening-normal.

The invention relates further to a laboratory system. The laboratory system comprises the laboratory apparatus as described above and a, in particular the, transport device. The transport device is adapted for passing through the through-opening of the housing of the laboratory apparatus for transporting, in particular the, laboratory sample containers in and/or out of the housing. This, in particular the cover with its ring segments adjustable between the distant adjustment and the near adjustment, enables firstly and, thus, easy passing the transport device through the through-opening of the housing and secondly the easy assembly of the cover at the housing. In particular the cover with its ring segments in the near adjustment may comprise an internal or inner, respectively, shape or cross-section or edge, respectively, form-fitting or corresponding, in particular completely, respectively, to an external or outer, respectively, shape or cross-section or edge, respectively, of the transport device. In other words: The cover may protrude or extend, respectively, at least from, in particular over, the outer edge of the through-opening and/or to the transport device, in particular in contact with the transport device. In particular the contact may be direct and/or physical. Additionally or alternatively the term “touch” may be used synonymously for the term “contact”. Additionally or alternatively the laboratory system may comprise the laboratory sample containers.

According to an embodiment of the invention, the transport device comprises an alignment mechanism. The alignment mechanism is adapted for aligning the transport device with respect to the laboratory apparatus, in particular its housing, in particular its through-opening, and/or a, in particular the, support, in particular a, in particular the, ground floor, for supporting the transport device. In particular the through-opening defines an, in particular the, opening-normal. The alignment mechanism is adapted for aligning the transport device at least along, in particular the, at least one direction being non-parallel, in particular orthogonal, to the opening-normal. This enables a compensation of or overcoming, respectively, an unevenness of the support and/or a set up inaccuracy. In particular the alignment mechanism may be adapted for aligning the transport device along, in particular exactly, two directions being non-parallel, in particular orthogonal, to the opening-normal.

According to an embodiment of the invention, the transport device comprises a transport plane. The transport plane is adapted for supporting, in particular the, laboratory sample containers for movements of the laboratory sample containers on top of the transport plane. In particular the transport device may comprise a plane housing. The plane housing may, in particular continuously or uninterruptedly or completely, respectively, house or surround, respectively, the transport plane. Additionally or alternatively the transport plane, in particular and the plane housing, may be adapted for passing through the through-opening of the housing. Additionally or alternatively the transport plane may be a bottom transport plane and/or stationary. Additionally or alternatively the transport device, in particular the transport plane, may be adapted as disclosed in EP 2 773 968 B1. Reference is insofar made to the relevant technical literature.

The invention relates further to a use of the cover with the housing of the laboratory apparatus as described above and/or a laboratory system as described above.

### BRIEF DESCRIPTION OF THE DRAWINGS

In the following, embodiments of the invention will be described in detail with reference to the drawings. Throughout the drawings, the same elements will be denoted by the same reference numerals.

FIG. 1 schematically depicts a perspective view of a laboratory system according to the invention comprising a laboratory apparatus according to the invention and a transport device,

FIG. 2 schematically depicts a perspective view of the laboratory apparatus of FIG. 1 comprising a housing and a cover in a near adjustment,

FIG. 3 schematically depicts a perspective view of the cover of FIG. 2,

FIG. 4 schematically depicts a perspective view of the cover of FIG. 2 in a distant adjustment,

FIG. 5 schematically depicts a perspective view of another laboratory apparatus according to the invention comprising a housing and a cover in a near adjustment and mounting and/or fixing means, and

FIG. 6 schematically depicts an enlarged view of the laboratory apparatus of FIG. 5.

### DETAILED DESCRIPTION OF EMBODIMENTS OF THE INVENTION

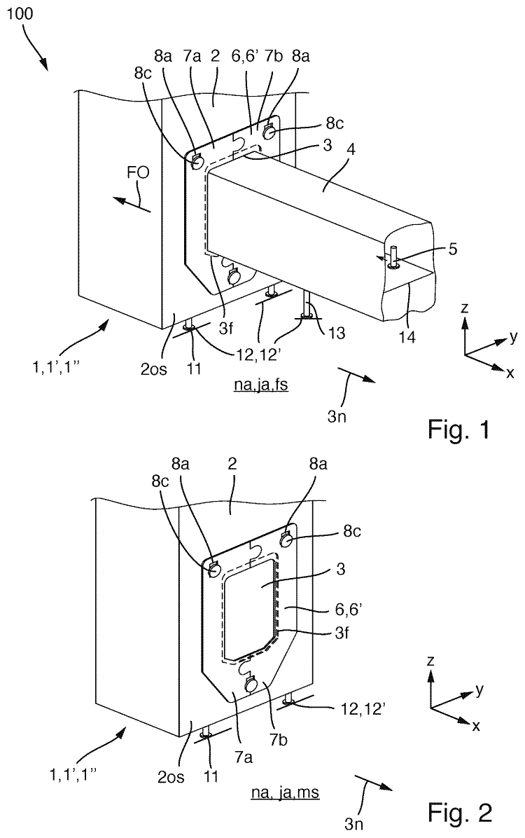

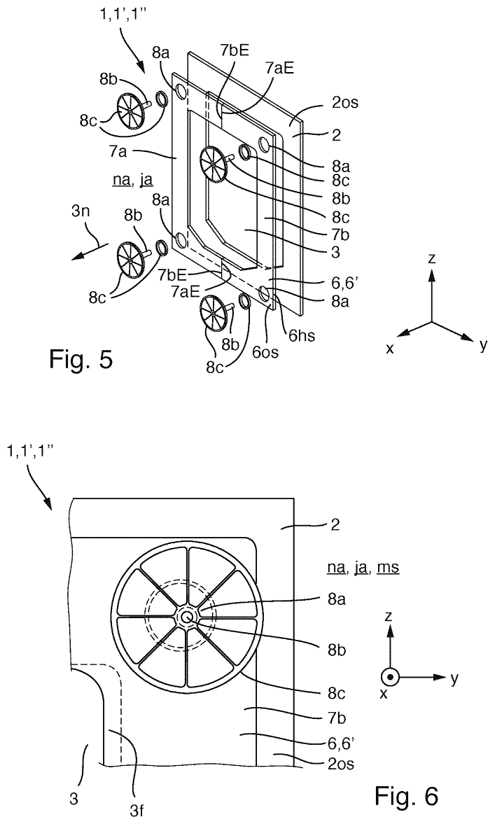

FIG. 1 schematically depicts a perspective view of a laboratory system 100 according to the invention. The laboratory system 100 comprises a laboratory apparatus 1 according to the invention, which is schematically depicted in FIGS. 1 and 2 as well as in FIGS. 5 and 6, and a transport device 4.

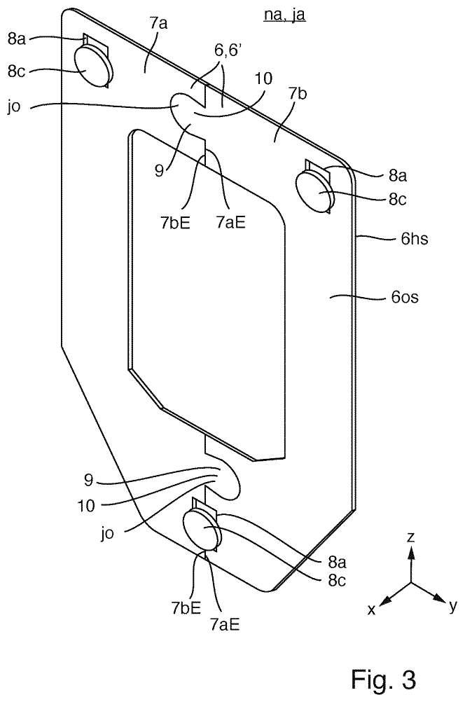

The laboratory apparatus 1 comprises a housing 2 and a cover 6, which is schematically depicted in FIGS. 1 to 4 as well as in FIGS. 5 and 6. The housing 2 comprises a through-opening 3. The through-opening 3 is adapted for passing through it the transport device 4 for transporting laboratory sample containers 5, one of which is schematically depicted in FIG. 1, in and/or out of the housing 2.

The transport device 4 is adapted for passing through, in particular passes through, the through-opening 3 of the housing 2 of the laboratory apparatus 1 for transporting, in particular transports, the laboratory sample containers 5 in and/or out of the housing 2.

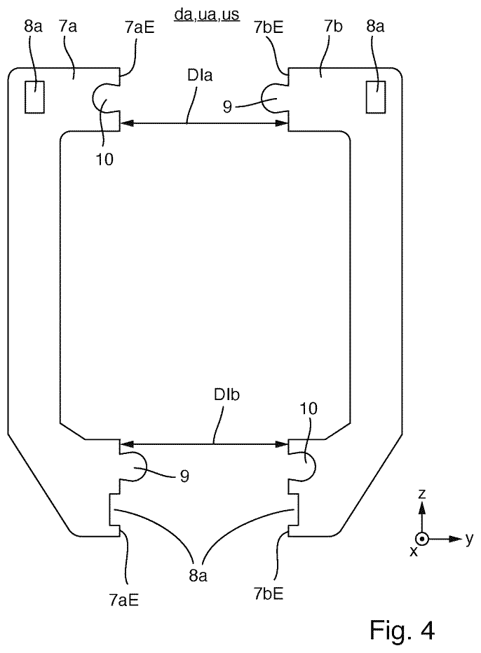

The cover 6 comprises at least two ring segments 7a, 7b. The ring segments 7a, 7b are adjustable, in particular adjusted, to each other between a distant adjustment da with at least one distance DIa, DIb in between ends 7aE, 7bE of the ring segments 7a, 7b for arranging them around the passed through transport device 4, which is schematically depicted in FIG. 4, and a near adjustment na with less or no distance in between the ends 7aE, 7bE of the ring segments 7a, 7b for surrounding the passed through transport device 4, which is schematically depicted in FIGS. 1 to 3 as well as in FIGS. 5 and 6. The cover 6 in the near adjustment na is adapted to cover a part 3f of the through-opening 3 left free by the passed through transport device 4.

In the depicted embodiments the cover 6 comprises exactly two ring segments 7a, 7b, in particular in the distant adjustment da with exactly two distances DIa, DIb in between exactly four ends 7aE, 7bE of the ring segments 7a, 7b. In alternative embodiments the cover may comprise at least three ring segments, in particular in the distant adjustment with at least two, in particular at least three, distances in between at least four, in particular at least six, ends of the ring segments.

In particular the cover 6 or its ring segments 7a, 7b, respectively, are arranged around the passed through transport device 4 and surround the passed through transport device 4.

The cover 6 in the near adjustment na covers the part 3f of the through-opening 3.

In detail the cover 6, in particular in the near adjustment na, is displaceable, in particular displaced, along the through-opening 3.

In particular the through-opening 3 defines an opening-normal 3n.

The cover 6 is displaceable at least along at least one direction y, z being non-parallel, in particular orthogonal, to the opening-normal 3n.

In the depicted embodiments the one direction y is horizontal and the one direction z is vertical.

The cover 6 comprises an unmounted, and in particular unfixed, state us with the cover 6 unmounted, and in particular unfixed, with respect to the through-opening 3 for adjusting the ring segments 7a, 7b between the distant adjustment da and the near adjustment na, which is schematically depicted in FIG. 4, and/or a mounted, and in particular unfixed, state ms with the cover 6 mounted, and in particular unfixed, with respect to the through-opening 3 for displacing the cover 6 along the through-opening 3, which is schematically depicted in FIG. 2 as well as in FIG. 6, and/or a fixed state fs with the cover 6 fixed with respect to the through-opening 3 for covering the part 3f of the through-opening 3, which is schematically depicted in FIG. 1.

The laboratory apparatus comprises mounting and/or fixing means 8a, 8b, 8c. The mounting and/or fixing means 8a, 8b, 8c are adapted for mounting and/or fixing, in particular mount and/or fix, the cover 6 with respect to the through-opening 3 and comprise: a plurality of through-holes 8a in the cover 6, in particular in at least one of the ring segments 7a, 7b and/or extending from a housing side 6hs of the cover 6 to an opposite side 6os of the cover 6, a plurality of shafts 8b and a plurality of rest elements 8c. The plurality of shafts 8b is adapted for passing through, in particular passes through, the plurality of through-holes 8a from the housing 2 away, in particular from the housing side 6hs of the cover 6 to the opposite side 6os of the cover 6. The plurality of rest elements 8c is adapted for resting, in particular rests, on the cover 6, in particular at its opposite side 6os, and for applying, in particular applies, a force FO to the cover 6 towards the housing 2 by means of the plurality of shafts 8b, in particular passing through the plurality of through-holes 8a. In particular the plurality of through-holes 8a, the plurality of shafts 8b and the plurality of rest elements 8c are dimensioned for the mounted state ms and/or the fixed state fs.

In the embodiment depicted in FIGS. 1 to 4 the mounting and/or fixing means 8a, 8b, 8c comprise three through-holes 8a, three shafts 8b and three rest elements 8c. In the embodiment depicted in FIGS. 5 and 6 the mounting and/or fixing means 8a, 8b, 8c comprise four through-holes 8a, four shafts 8b and four rest elements 8c. In alternative embodiments the mounting and/or fixing means may comprise at least two through-holes, at least two shafts and at least two rest elements.

In the embodiment depicted in FIGS. 1 to 4 the plurality of through-holes 8a are dimensioned longer in the direction z than in the direction y. This enables a greater tolerance of an alignment of the housing 2, in particular its through-opening 3, and the transport device 4, in particular passing through the through-opening 3, to each other in the direction z than in the direction y. This enables passing the transport device 4 through the through-opening 3 in a shovel movement.

The cover 6 is adapted for resting, in particular rests, on the housing 2, in particular at its outside 2os, for covering the part 3f of the through-opening 3.

The cover 6, in particular in the near adjustment na, is a cover plate 6′.

The housing 2, in particular at its outside 2os, in the region of its through-opening 3 is plane.

The distant adjustment da is an unjoined adjustment ua with no joint between the ends 7aE, 7bE of the ring segments 7a, 7b. The near adjustment na is a joined adjustment ja with at least one joint jo between the ends 7aE, 7bE of the ring segments 7a, 7b.

In the embodiment depicted in FIGS. 1 to 4 the joined adjustment ja is with exactly two joints jo between the ends 7aE, 7bE of the ring segments 7a, 7b. In alternative embodiments the joined adjustment may be with at least one joint or at least three joints between the ends of the ring segments.

The ring segments 7a, 7b, in particular with their ends 7aE, 7bE, are adjustable, in particular adjusted, to each other between the distant adjustment da and the near adjustment na at least, in particular firstly, sectionally along the at least one direction y being non-parallel, in particular orthogonal, to the opening-normal 3n and/or at least, in particular secondly, sectionally along a direction x being non-orthogonal, in particular parallel, to the opening-normal 3n.

In the depicted embodiments the direction x is horizontal.

At least one of the ring segments 7a, 7b comprises at its end 7aE, 7bE a tab 9 and at least another one of the ring segments 7b, 7a comprises at its end 7bE, 7aE a corresponding indentation 10 for receiving, in particular receives, the tab 9 for joining the ends 7aE, 7bE of the ring segments 7a, 7b, in particular for the joined adjustment ja.

In the embodiment depicted in FIGS. 1 to 4 each ring segment 7a, 7b comprises at its one end 7aE, 7bE a tab 9 and at its another one end 7aE, 7bE an indentation 10. In alternative embodiments one of the ring segments may comprise at its ends tabs and/or at least another one of the ring segments may comprise at its ends indentations.

The laboratory apparatus 1 is a pre-analytical, analytical, and/or post-analytical laboratory apparatus 1′, in particular a sorting module 1″.

The laboratory apparatus 1 comprises an alignment mechanism 11. The alignment mechanism 11 is adapted for aligning, in particular aligns, the housing 2, in particular with its through-opening 3, with respect to a support 12, in particular a ground floor 12′, for supporting the laboratory apparatus 1. In particular the alignment mechanism 11 is adapted for aligning the housing 2 at least along the at least one direction y, z being non-parallel, in particular orthogonal, to the opening-normal 3n.

The transport device 4 comprises an alignment mechanism 13. The alignment mechanism 13 is adapted for aligning, in particular aligns, the transport device 4 with respect to the laboratory apparatus 1, in particular its housing 2, in particular its through-opening 3, and/or the support 12, in particular the ground floor 12′, for supporting the transport device 4. In particular the alignment mechanism 13 is adapted for aligning the transport device 4 at least along the at least one direction y, z being non-parallel, in particular orthogonal, to the opening-normal 3n.

The transport device 4 comprises a transport plane 14. The transport plane 14 is adapted for supporting, in particular supports, laboratory sample containers 5 for movements of the laboratory sample containers 5 on top of the transport plane.

The cover 6 is used with the housing 2 of the laboratory apparatus 1 and/or the laboratory system 100.

In detail and/or other words:

In the embodiment depicted in FIGS. 1 to 4 the housing 6 itself comprises, in particular consists out of, two PMMA or plexiglas, respectively, segments 7a, 7b that are put together like a puzzle. That allows or enables, respectively, to attach the cover 6 after the housing 2 and the transport device 4 are aligned. To fix the cover 6 it is provided or equipped, respectively, with three slotted hole 8a. The slotted holes 8a are exactly as big as the tolerances are in between the housing 2 and the transport device 4. To fix the cover 6 towards the housing 2 three aluminum discs 8c are used. Those discs 8c are slightly greater or bigger, respectively, than the slotted holes 8a. This enables to fix the cover 6 in every position in a proper way. The discs 8c themselves are then fixed towards the housing 2 with three screws comprising the shafts 8b in the, in particular corresponding, center or middle, respectively.

In the embodiment depicted in FIGS. 5 and 6 the plurality of rest elements 8c is provided with rings. They keep the plexiglas in position. They are slightly greater or thicker, respectively, than the plexiglas to apply the force FO or pressure, respectively, of the discs 8c on the plexiglas. The discs 8c serve to force or to press, respectively, the rings and keep them in position. They, in particular each, will be fixed only with one screw in the middle.

1. A laboratory apparatus, wherein the laboratory apparatus comprises,
a housing, wherein the housing comprises a through-opening, wherein the through-opening is adapted for passing through it a transport device for transporting laboratory sample containers in and/or out of the housing, and
a cover, wherein the cover comprises at least two ring segments, wherein the at least two ring segments are adjustable to each other between
a distant adjustment (da) with at least one distance (DIa, DIb) in between ends of the ring segments for arranging them around the passed through transport device and
a near adjustment (na) with less or no distance in between the ends of the ring segments for surrounding the passed through transport device, and
wherein the cover in the near adjustment (na) is adapted to cover a part of the through-opening left free by the passed through transport device,
wherein the laboratory apparatus is a pre-analytical, analytical, and/or post-analytical laboratory apparatus.

2. The laboratory apparatus according to claim 1, wherein the laboratory apparatus is a sorting module.

3. The laboratory apparatus according to claim 1,
wherein the cover is displaceable along the through-opening wherein the through-opening defines an opening-normal, and
wherein the cover is displaceable at least along at least one direction (y, z) being non-parallel to the opening-normal.

4. The laboratory apparatus according to claim 3, wherein the cover is displaceable along the through-opening in the near adjustment (na).

5. The laboratory apparatus according to claim 4, wherein the at least one non-parallel direction is orthogonal to the opening-normal.

6. The laboratory apparatus according to claim 1,
wherein the cover comprises
an unmounted state (us) with the cover unmounted with respect to the through-opening for adjusting the ring segments between the distant adjustment (da) and the near adjustment (na), and/or
a mounted state (ms) with the cover mounted with respect to the through-opening for displacing the cover along the through-opening, and/or
a fixed state (fs) with the cover fixed with respect to the through-opening for covering the part of the through-opening.

7. The laboratory apparatus according to claim 1,
wherein the cover comprises an unfixed state (us) with the cover unfixed with respect to the through-opening for adjusting the ring segments between the distant adjustment (da) and the near adjustment (na), and/or
an unfixed state (ms) with the cover unfixed with respect to the through-opening for displacing the cover along the through-opening, and/or
a fixed state (fs) with the cover fixed with respect to the through-opening for covering the part of the through-opening.

8. The laboratory apparatus according to claim 1,
wherein the laboratory apparatus comprises mounting and/or fixing means, wherein the mounting and/or fixing means are adapted for mounting and/or fixing the cover with respect to the through-opening and comprising:
a plurality of through-holes in the cover in at least one of the ring segments and/or extending from a housing side of the cover to an opposite side of the cover,
a plurality of shafts, wherein the plurality of shafts is adapted for passing through the plurality of through-holes from the housing away from the housing side of the cover to the opposite side of the cover, and
a plurality of rest elements, wherein the plurality of rest elements is adapted for resting on the cover at its opposite side, and for applying a force (FO) to the cover towards the housing by means of the plurality of shafts,
wherein the plurality of through-holes, the plurality of shafts and the plurality of rest elements are dimensioned for the mounted state (ms) and/or the fixed state (fs).

9. The laboratory apparatus according to claim 8, wherein the rest elements are for applying a force (FO) by means of the plurality of shafts passing through the plurality of through holes.

10. The laboratory apparatus according to claim 1, wherein the cover is adapted for resting on the outside of the housing for covering the part of the through-opening.

11. The laboratory apparatus according to claim 1, wherein the cover, in the near adjustment (na), is a cover plate, and/or wherein the housing, at its outside in the region of its through-opening is plane.

12. The laboratory apparatus according to claim 1,
wherein the distant adjustment (da) is an unjoined adjustment (ua) with no joint between the ends of the ring segments, and
wherein the near adjustment (na) is a joined adjustment (ja) with at least one joint (jo) between the ends of the ring segments.

13. The laboratory apparatus according to claim 1,
wherein the through-opening defines an opening-normal, and
wherein the ring segments are adjustable to each other between the distant adjustment (da) and the near adjustment (na) at least sectionally along at least one direction (y) being non-parallel to the opening-normal and/or at least sectionally along a direction (x) being non-orthogonal to the opening-normal.

14. The laboratory apparatus according to claim 13 in which the rings are adjustable to each other between the distant adjustment and the near adjustment along the direction orthogonal to the opening-normal and along the direction parallel to opening-normal.

15. The laboratory apparatus according to claim 1,
wherein at least one of the ring segments comprises at its end a tab and at least another one of the ring segments comprises at its end a corresponding indentation for receiving the tab for joining the ends of the ring segments.

16. The laboratory apparatus according to claim 15 wherein the at least one of the ring segments comprises at its end a tab and at least another one of the ring segments comprises at its end a corresponding indentation for receiving the tab for joining the ends of the ring segments.

17. The laboratory apparatus according to claim 1,
wherein the laboratory apparatus comprises an alignment mechanism, wherein the alignment mechanism is adapted for aligning the housing with its through-opening, with respect to a support for supporting the laboratory apparatus.

18. The laboratory apparatus according to claim 17,
wherein the through-opening defines an opening-normal, and wherein the alignment mechanism is adapted for aligning the housing at least along at least one direction (y, z) being non-parallel to the opening-normal.

19. A laboratory system, wherein the laboratory system comprises:
a laboratory apparatus according to claim 1, and
a transport device, wherein the transport device is adapted for passing through the through-opening of the housing of the laboratory apparatus for transporting laboratory sample containers in and/or out of the housing.

20. The laboratory system according to claim 19,
wherein the transport device comprises an alignment mechanism, wherein the alignment mechanism is adapted for aligning the transport device with respect to the laboratory apparatus and/or a support for supporting the transport device.

21. The laboratory system according to claim 20, wherein the through-opening defines an opening-normal, and wherein the alignment mechanism is adapted for aligning the transport device at least along at least one direction (y, z) being non-parallel to the opening-normal.

22. The laboratory system according to claim 21,
wherein the transport device comprises a transport plane, wherein the transport plane is adapted for supporting laboratory sample containers for movements of the laboratory sample containers on top of the transport plane.
